(19) United States
(12) Patent Application Publication
(10) Pub. No.: US 2017/0285522 A1
(43) Pub. Date: Oct. 5, 2017

(54) Systems and Methods for Storing and Shipping Toner Bags

(71) Applicant: Static Control Components, Inc., Sanford, NC (US)

(72) Inventor: Jonathan W. Martin, Fayetteville, NC (US)

(21) Appl. No.: 15/468,549

(22) Filed: Mar. 24, 2017

Related U.S. Application Data
(60) Provisional application No. 62/317,869, filed on Apr. 4, 2016.

(51) Int. Cl. B65D 85/00

(52) U.S. Cl. CPC G03G 15/0874

(57) ABSTRACT

A method of packaging a flexible toner bag holding toner including placing the toner bag in a reduced pressure bag; removing at least a portion of the air inside the reduced pressure bag; and sealing an opening of the reduced pressure bag to form a reduced pressure bag assembly.

The present application claims the benefit of U.S. Provisional Patent Application Ser. No. 62/317,889, filed Apr. 4, 2016, entitled “Method for Storing and Shipping Toner Bags”, which is incorporated by reference herein in its entirety.

### BACKGROUND

The present invention generally relates to toner containers, seals, and the like, and more particularly to techniques for storing and shipping a toner container which holds toner in a printer toner cartridge or the like.

In the imaging industry, there is a growing market for the remanufacture and refurbishing of various types of replaceable imaging cartridges such as toner cartridges, drum cartridges, inkjet cartridges, and the like. These imaging cartridges are used in imaging devices such as laser printers, xerographic copiers, inkjet printers, and facsimile machines, for example. Imaging cartridges, once spent, are unusable for their originally intended purpose. Without a refurbishing process these cartridges would simply be discarded, even though the cartridge itself may still have potential life. As a result, techniques have been developed specifically to address this issue. These processes may entail, for example, the disassembly of the various structures of the cartridge, replacing toner or ink, cleaning, adjusting or replacing any worn components and reassembling the imaging cartridge.

Imaging cartridges include one or more compartments holding the marking material which is deposited on a surface, such as paper. For a laser toner cartridge, this compartment may be referred to as the toner hopper. Some printers include a sealed bag filled with toner disposed in the hopper. The seal is attached to the bag is removed prior to installation or by the printer after installation. When remanufacturing such an imaging cartridge it is desirable to replace the toner bag.

This replacement toner bag must be shipped to a customer for installation in the toner cartridge. The toner bag may include a breathable backing material, such as a polyester micro-fiber blend, which allows toner to bleed through after some handling. Also, the seal may be applied with low force by design and could be easily ruptured. Due to the mechanical aspects of the toner bag, shipping the toner bag may create problems. Therefore, a viable shipping method must be developed in order to ship a toner bag successfully without damage.

### SUMMARY

In one aspect of the present invention, a method of packaging a flexible toner bag holding toner includes placing the toner bag in a reduced pressure bag; removing at least a portion of the air inside the reduced pressure bag; and sealing an opening of the reduced pressure bag to form a reduced pressure bag assembly.

A more complete understanding of the present invention, as well as further features and advantages of the invention, will be apparent from the following detailed description and the accompanying drawings.

### BRIEF DESCRIPTION OF THE DRAWINGS

FIG. 1 shows an isometric view of a toner bag assembly in accordance with aspects of the present invention; and

FIG. 2 shows an isometric view of a toner bag, toner bag seal and agitator in accordance with aspects of multiple embodiments the present invention.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The following detailed description of preferred embodiments refers to the accompanying drawings, which illustrate specific embodiments of the invention. In the discussion that follows, specific systems and techniques for repairing, manufacturing, or remanufacturing an imaging cartridge, such as a toner cartridge, are described. Other embodiments having different structures and operations for the repair, remanufacture, and operation of other types of replaceable imaging components and for various types of imaging devices, such as laser printers, inkjet printers, copiers, facsimile machines and the like, do not depart from the scope of the present invention.

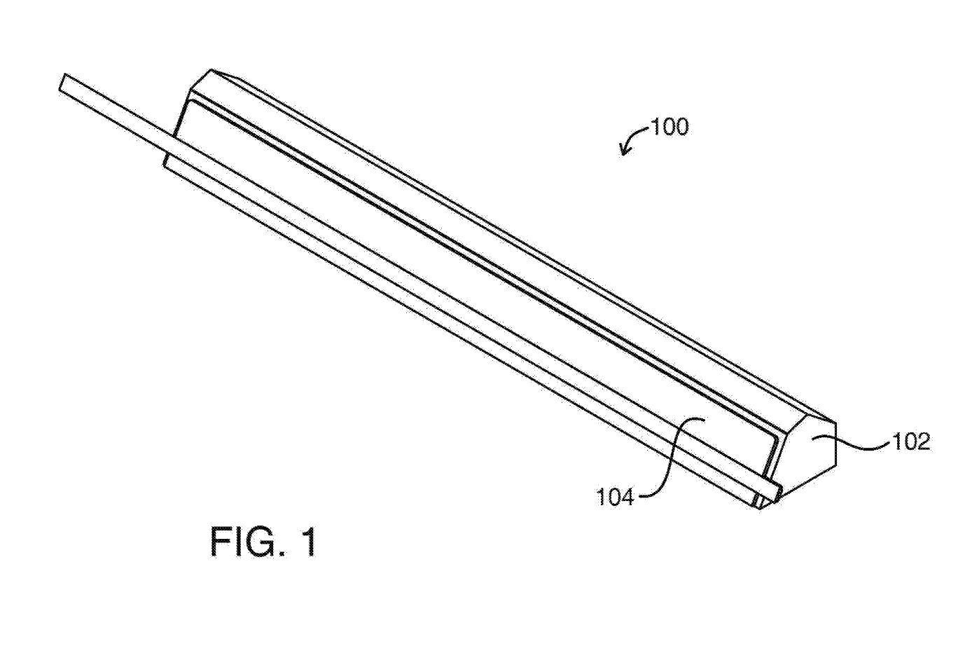

FIG. 1 shows a toner bag assembly 100 in accordance with the present invention. The toner bag assembly 100 includes a toner bag 102 holding toner. A seal 104 covers one or more exit ports in the toner bag 102 and is adapted for removal to allow toner to flow from the exit ports of the toner bag 102 when a toner cartridge holding the toner bag 102 is in operation. The bag 102 may be shipped to a customer for installation in a toner cartridge. The toner bag 102 may comprise a breathable backing material, such as a polyester micro-fiber blend, which allows toner to bleed through after some handling. Also, the seal 104 may be applied with low force and could be easily ruptured. Due to the mechanical aspects of the toner bag 102, shipping the toner bag assembly 100 may create problems.

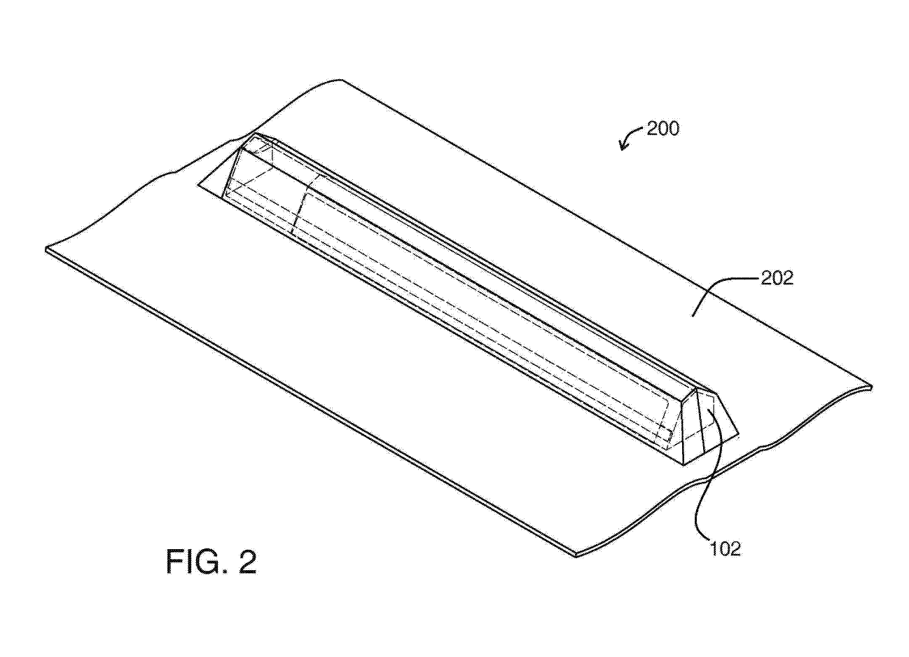

In one aspect of the present invention, a new toner bag assembly 100 is packed in a reduced pressure bag assembly 200, as shown in FIG. 2. The reduced pressure bag assembly 200 includes a reduced pressure bag 202 which has had at least a portion of the air inside evacuated to reduce the pressure inside the bag 202 to a pressure less than standard atmospheric pressure (29.92 in. Hg). The reduced pressure bag 202 may advantageously compress the toner in the toner bag 102 into hardness similar to chalk, preventing bleed through. The reduced pressure bag 202 may apply compression to the seal 104, preventing the seal 104 separating from the toner bag 102 and spilling toner during shipping or handling. The reduced pressure bag assembly 200 provides a robust package for the toner bag 102 to withstand a reasonable amount of rough handling without damage. After the reduced pressure bag assembly 200 has been transported to a destination, the toner bag assembly 100 is removed from the bag 202 and installed in a toner cartridge.

The reduced pressure bag 202 may comprise any suitable material which can be sealed and maintain the reduced pressure within the reduced pressure bag 202. For example, the reduced pressure bag 202 may comprise a vacuum packaging bag used in the food industry, such as Vacmaster's (product number 947152) roll of vacuum packaging bag material made from polyethene and nylon, having a thickness of 3 mils. A Vollrath vacuum sealer model no. 40858 can be used to remove air from the bag 202 and heat seal the opening. Preferably, the sealed reduced pressure bag 202 results in an internal pressure of 25-0 inches Hg, and even more preferably 25-18 inches Hg, but any suitable reduced pressure can be used to seal the toner within the cartridge

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of packaging a flexible toner bag holding toner comprising:
placing the toner bag in a reduced pressure bag;
removing at least a portion of the air inside the reduced pressure bag; and
sealing an opening of the reduced pressure bag to form a reduced pressure bag assembly.

2. The method of claim 1 wherein the air pressure inside the reduced pressure bag assembly is less than 29 inches Hg.

3. The method of claim 2 wherein the air pressure inside the reduced pressure bag assembly is less than 25 inches Hg.

4. The method of claim 3 wherein the air pressure inside the reduced pressure bag assembly is greater than 18 inches Hg.

5. A reduced pressure bag assembly comprising:
a toner bag holding toner; and
a reduced pressure bag holding the toner bag;
wherein the air pressure inside the reduced pressure bag is less than 29 inches Hg.

6. The assembly of claim 5 wherein the air pressure inside the reduced pressure bag assembly is less than 29 inches Hg.

7. The assembly of claim 6 wherein the air pressure inside the reduced pressure bag assembly is less than 25 inches Hg.

8. The assembly of claim 7 wherein the air pressure inside the reduced pressure bag assembly is greater than 18 inches Hg.
